(19) United States
(12) Patent Application Publication
(10) Pub. No.: US 2023/0066428 A1
(43) Pub. Date: Mar. 2, 2023

(54) SWAPPABLE BATTERY PACK SYSTEM AND A METHOD THEREOF

(71) Applicant: EXICOM TELE-SYSTEMS LIMITED, Gurgaon (IN)

(72) Inventors: H.S. Bhatia, Bangalore (IN); Naresh Kumar, Bangalore (IN); Rishir Kumar, Bangalore (IN)

(73) Assignee: EXICOM TELE-SYSTEMS LIMITED, gURGAON (IN)

(21) Appl. No.: 17/796,063

(22) PCT Filed: Jan. 27, 2021
(86) PCT No.: PCT/IN2021/050083

§ 371 Date: Jul. 28, 2022

(30) Foreign Application Priority Data
Jan. 31, 2020 (IN) 202011004331

(51) Int. Cl. H01M 50/244; H01M 50/204; H01M 50/249; H01M 50/258; H01M 50/264

(52) U.S. Cl. CPC H01M 50/244; H01M 50/204; H01M 50/249; H01M 50/258; H01M 50/264; H01M 2220/20; B60L 53/80

(57) ABSTRACT

A swappable battery pack system includes a casing and a battery pack. A first pair of rail elements, a first pair of guide elements and a first connector are positioned on an inner surface of at least one of a side plane of the casing. A battery pack adapted to be slidably disposed within the casing includes a second pair of guide elements, rail elements and a second connector coupled to the outer surface of the battery pack. In the event of sliding the battery pack within the casing, the first pair of rail elements engage with the second pair of guide elements, the first pair of guide elements engage with the second pair of rail elements and the first connector is received within the second connector to form a complete connection, thereby providing power to an entity affixed to the casing.

### FIELD OF THE INVENTION

The present invention relates to swappable battery packs and more particularly relates to swappable battery pack system and a method thereof.

### BACKGROUND OF THE INVENTION

It is well known in the art that a battery pack provides power to the electric vehicle. The battery pack is generally disposed within a casing and the casing is affixed to a frame structure of the vehicle. To run the electric vehicle, a high capacity battery pack is required. The capacity refers to the amount of charge available in the battery pack. During motion of the vehicle, the charge available in the battery pack gradually decreases and eventually will be out of charge. During this situation, the battery pack has to be recharged using specific chargers. Recharging a battery pack is time consuming. An alternate option is to swap the out of charge battery pack with a fresh battery pack. Due to the requirement of the high capacity battery pack for the electric vehicle, the weight of the battery pack in turn will be heavy. Hence, swapping the battery pack with the fresh battery pack is difficult and a tedious job.

The swapping process usually includes disengaging the out of charge battery pack from the casing, pulling out the said battery pack, disposing the fresh battery pack within the casing and engaging the fresh battery pack with the casing so that the fresh battery pack provides power to the vehicle. Companies in the electric vehicle space are looking at providing swappable battery pack systems and methods which can be operated by the driver of the electric vehicle instead of having teams present at the swapping stations to conduct this operation.

In the event of disengaging and while pulling out the battery pack from the casing by the driver, the battery pack may orient in a particular direction due to its heavy weight which could prevent or make it difficult to pull out the battery pack from the casing for the driver.

Further, while disposing the fresh battery pack within the casing by the driver, there are possibilities of the battery pack getting jammed at the open end of the casing when it is not aligned with reference to the casing. Further, the driver has to ensure that the connector of the battery pack comes in contact with the connector of the battery pack when the fresh battery pack is disposed within the casing to power the electric vehicle. If the battery pack disposed within the casing is not properly aligned with reference to the casing, then the two connectors will not come in contact with each other, thereby not powering the vehicle. To overcome the drawback of the two connectors not contacting each other, existing mechanisms include the battery pack being first disposed within the casing and thereafter connecting the connector to the battery pack and the casing. This mechanism can consume a lot of work and also includes additional installation steps and hardware, thereby increasing the time and cost. Also, a skilled professional may be required to conduct these steps of swapping. Assuming, that the driver conducts the swapping operation, there are possibilities of electric shock being caused to the driver by energized parts of the swappable systems such as connectors and the associated wires, if not properly handled. These kind of incidents can be detrimental to the driver, since the battery packs used in electric vehicles operate at high voltages.

Further, the heavy weight of the battery pack may damage parts such as, the connector of the battery pack, connector of the casing or any other parts of the vehicle during situations such as misalignment of the battery pack within the casing.

In case the battery pack is disposed within the casing with proper alignment, even then there is no guarantee that the connection formed in response to contact of the two connectors may remain intact. There are possibilities of the connection being broken due to impact caused by movement of the vehicle.

Certain existing electric vehicles in the market are being converted from petrol/diesel based vehicles to electric vehicles. Therefore, the converted electric vehicles do not have swappable battery pack friendly systems and methods. In this regard, pulling out the out of charge battery pack and disposing the fresh battery pack in the converted electric vehicle will be difficult and expensive.

### SUMMARY OF THE INVENTION

One or more embodiments of the present invention provide a swappable battery pack system and a method thereof.

In one aspect of the invention, a swappable battery pack system is provided. The swappable battery pack system includes a casing having a first, a second, a third and a fourth side plane coupled to each other to define a hollow space. A first pair of rail elements having a first length (L1) is defined on an inner surface and parallel to a longitudinal axis of each of the first and the third side plane. A first pair of guide elements having a second length (L2) is defined on the inner surface of one of the first and the third side plane and parallel to the longitudinal axis of one of the first and the third side plane. A first connector is coupled on the inner surface and adjacent to a first end of one of the first and the third side plane and positioned in between the first pair of guide elements. The swappable battery pack system further includes a battery pack. The battery pack is adapted to be disposed within the casing. The battery pack has a second pair of guide elements and a second pair of rail elements defined on an outer surface of the battery pack so as to abut against the first pair of rail elements and the first pair of guide elements and a second connector is coupled to one end of the outer surface of the battery pack. When the battery pack is disposed within the casing, the first pair of rail elements of the casing engage with the second pair of guide elements of the battery pack to form a first connection. Further, the first pair of guide elements of the casing engage with the second pair of rail elements of the battery pack to form a second connection subsequent to the first connection. Further, the first connector of the casing is received within the second connector of the battery pack to form a third connection subsequent to the second connection, thereby providing electric power to an entity affixed to the casing.

In another aspect of the invention, a casing for a swappable battery pack is provided. The casing includes a first, a second, a third and a fourth side plane coupled to each other to define a hollow space. The casing further includes a first pair of rail elements having a first length (L1) defined on an inner surface and parallel to a longitudinal axis of each of the first and the third side plane. The casing further includes a first pair of guide elements having a second length (L2) defined on the inner surface of one of the first and the third side plane and parallel to a longitudinal axis of one of the first and the third side plane. A first connector is coupled to a first end of the inner surface of one of the first and the third side plane and positioned in between the first pair of guide elements. In the event of sliding a battery pack within the casing, the first pair of rail elements of the casing engage with a corresponding second pair of guide elements of the battery pack to form a first connection. The first pair of guide elements of the casing engage with a corresponding second pair of rail elements of the battery pack to form a second connection subsequent to the first connection. The first connector of the casing is received within a corresponding second connector of the battery pack to form a third connection subsequent to the second connection, thereby providing electric power to an entity affixed to the casing.

In yet another aspect of the invention, a swappable battery pack is provided. The swappable battery pack includes a second pair of guide elements and a second pair of rail elements defined on an outer surface of the battery pack and parallel to a longitudinal axis of the battery pack so as to abut against a corresponding first pair of rail elements and a first pair of guide elements of a casing, and a second connector coupled to one end on the outer surface of the battery pack. In the event of sliding the battery pack within a casing, the second pair of guide elements of the battery pack engage with the corresponding first pair of rail elements of the casing to form a first connection. Further, the second pair of rail elements of the battery pack engage with the corresponding first pair of guide elements of the casing to form a second connection subsequent to the first connection. Further, the second connector receives a corresponding first connector to form a third connection subsequent to the second connection, thereby providing electric power to an entity affixed to the casing.

In yet another aspect of the invention, a method for providing a swappable battery pack within a casing is provided. The method comprises the steps of, coupling a first, a second, a third, and a fourth side plane to each other to form the casing defining a hollow space therein. A first pair of rail elements having a first length is defined on an inner surface and parallel to a longitudinal axis of each of the first and the third side plane. A first pair of guide elements having a second length is defined on the inner surface of one of the first and the third side plane and parallel to the longitudinal axis of one of the first and the third side plane. A first connector is coupled on the inner surface, adjacent to a first end of one of the first and the third side plane and positioned in between the first pair of guide elements. The battery pack is slidably disposed within the casing. The battery pack has a second pair of guide elements and a second pair of rail elements defined parallel to a longitudinal axis on an outer surface of the battery pack so as to abut against the first pair of rail elements and the first pair of guide elements. A second connector is coupled to one end of the outer surface of the battery pack. In the event of sliding the battery pack within the casing, the first pair of rail elements of the casing engage with the second pair of guide elements of the battery pack forming a first connection. Further, the first pair of guide elements of the casing engage with the second pair of rail elements of the battery pack forming a second connection subsequent to the first connection. Further, the first connector of the casing is received within the second connector of the battery pack forming a third connection subsequent to the second connection, thereby providing electric power to an entity affixed to the casing.

Other features and aspects of this invention will be apparent from the following description and the accompanying drawings. The features and advantages described in this summary and in the following detailed description are not all-inclusive, and particularly, many additional features and advantages will be apparent to one of ordinary skill in the relevant art, in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

Reference will be made to embodiments of the invention, examples of which may be illustrated in the accompanying figures. These figures are intended to be illustrative, not limiting. The accompanying figures, which are incorporated in and constitute a part of the specification, are illustrative of one or more embodiments of the disclosed subject matter and together with the description explain various embodiments of the disclosed subject matter and are intended to be illustrative. Further, the accompanying figures have not necessarily been drawn to scale, and any values or dimensions in the accompanying figures are for illustration purposes only and may or may not represent actual or preferred values or dimensions. Although the invention is generally described in the context of these embodiments, it should be understood that it is not intended to limit the scope of the invention to these particular embodiments.

FIG. 1 is a perspective view of a swappable battery pack system, according to one or more embodiments of the present invention;

FIG. 2 is a perspective view of a casing and a battery pack of the swappable battery pack system of FIG. 1, according to one or more embodiments of the present invention;

FIG. 3 is a sectional view of an inner surface of each side plane of a casing of the swappable battery system of FIG. 1, according to one or more embodiments of the present invention;

FIG. 4 is a front view of a casing of the swappable battery pack system of FIG. 1, according to one or more embodiments of the present invention;

FIG. 5 illustrates an outer surface of each plane of the battery pack of FIG. 2, according to one or more embodiments of the present invention;

FIG. 6A is a perspective view illustrating a first connection formed in the event of disposing the battery pack within the casing, according to one or more embodiments of the present invention;

FIG. 6B is a perspective view illustrating a second connection formed in the event of disposing the battery pack within the casing, according to one or more embodiments of the present invention;

FIG. 6C is a perspective view illustrating a third connection formed in the event of disposing the battery pack within the casing, according to one or more embodiments of the present invention;

FIG. 6D is a perspective view illustrating a complete connection formed in the event of disposing the battery pack within the casing, subsequent to establishment of the first connection, second connection and the third connection, according to one or more embodiments of the present invention;

FIG. 7A is a sectional view illustrating a locked position between a first interlocking element of the battery pack and a second interlocking element of the casing, according to one or more embodiments of the present invention;

FIG. 7B is a sectional view illustrating an open position between a first interlocking element of the battery pack and a second interlocking element of the casing, according to one or more embodiments of the present invention;

FIG. 8 illustrates a working example of the swappable battery pack system, according to one or more embodiments of the invention;

FIG. 9 illustrates a flowchart of a working example of the swappable battery pack system, according to one or more embodiments of the invention; and

FIG. 10 is a flowchart of a method of providing a battery pack within a casing, according to one or more embodiments of the present invention.

### DETAILED DESCRIPTION OF THE INVENTION

Reference will now be made in detail to specific embodiments or features, examples of which are illustrated in the accompanying drawings. Wherever possible, corresponding or similar reference numbers will be used throughout the drawings to refer to the same or corresponding parts. References to various elements described herein, are made collectively or individually when there may be more than one element of the same type. However, such references are merely exemplary in nature. It may be noted that any reference to elements in the singular may also be construed to relate to the plural and vice-versa without limiting the scope of the invention to the exact number or type of such elements unless set forth explicitly in the appended claims. Moreover, relational terms such as first and second, and the like, may be used to distinguish one entity from the other, without necessarily implying any actual relationship or between such entities.

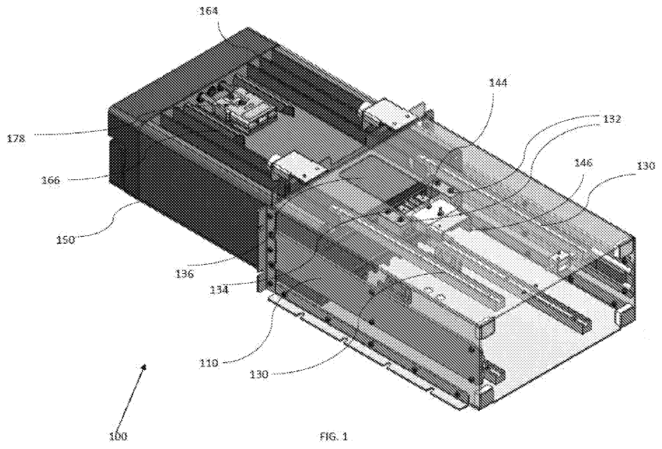

FIG. 1 illustrates a swappable battery pack system 100. The system 100 includes a casing 110 and a battery pack 150. The battery pack 150 is adapted to be slidably disposed within the casing 110. In order to clearly explain the various parts of the system 100, the battery pack 150 is partially disposed within the casing 110 in FIG. 1.

It is well known in the art that the battery pack 150 includes a plurality of cells (not shown) arranged in series and/or parallel combination.

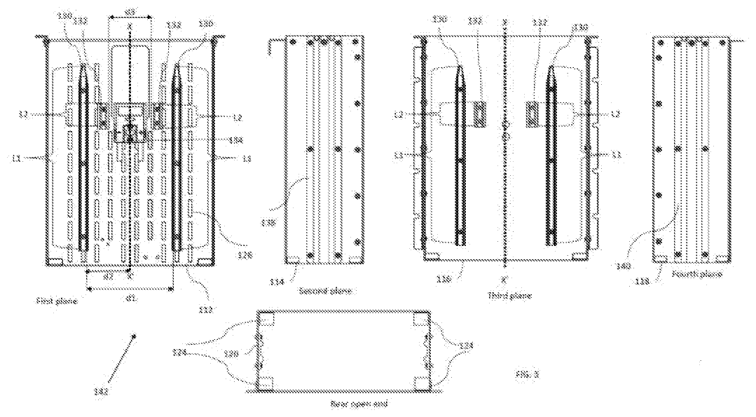

FIG. 3 illustrates a sectional view of an inner surface 142 of each side plane of the casing 110, according to one or more embodiments of the invention. With reference to FIG. 3, the casing 110 includes four side planes coupled to each other to define a hollow space therein. The four side planes as shown in FIG. 3 are termed herein as a first side plane 112, a second side plane 114, a third side plane 116 and a fourth side plane 118.

In an embodiment, the casing 110 can be of any other shapes, such as, but not limited to, cylindrical and conical. Based on the shapes of the casing 110 the number of side planes may vary.

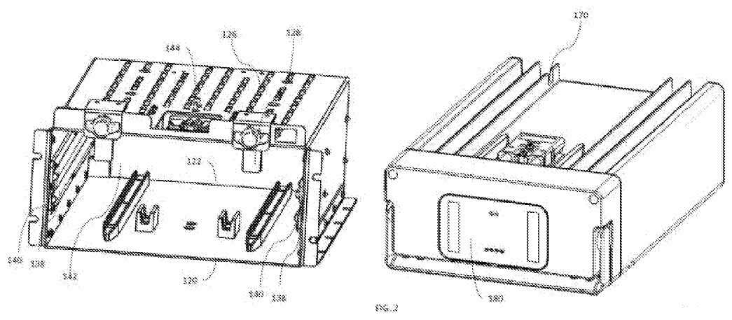

Further, the casing 110 includes a front open end 120 and a rear open end 122 as shown in FIG. 3 and more clearly illustrated in FIG. 2. The front open end 120 is adapted to receive the battery pack 150. The rear open end 122 includes a plurality of blockers 124 to arrest the movement of the battery pack 150 beyond the rear open end 122, once it is disposed within the casing as shown FIG. 3. In the present embodiment, four blockers 124 are present on the periphery of the rear open end 122 to arrest the movement of the battery pack beyond the rear open end 122. In alternate embodiments, the blockers 124 can be more than four or less than four to perform the function.

In an alternate embodiment, the casing 110 may have a rear plane (not shown) coupled to the four side planes namely the first side plane 112, the second side plane 114, the third side plane 116 and the fourth side plane 118. The rear plane may perform a similar function as the four blockers 124 to arrest the movement of the movement of the battery pack beyond the rear plane.

In an embodiment, the first side plane 112 is oppositely positioned to the third side plane 116 and the second side plane 114 is oppositely positioned to the fourth side plane 118 as shown in FIG. 2.

With reference to FIG. 2, the front open end 120 is adapted to receive the battery pack 150.

Further, at least one of the first, second, third and fourth side plane (112, 114, 116, 118) includes a plurality of air vents 126 as shown in FIG. 2 and FIG. 3. In the present embodiment, the plurality of air vents 126 is located on the first side lane 112 of the casing 110 as shown in FIG. 2. The plurality of air vents 126 is adapted to dissipate heat during the operation of the battery pack 150 within the casing 110.

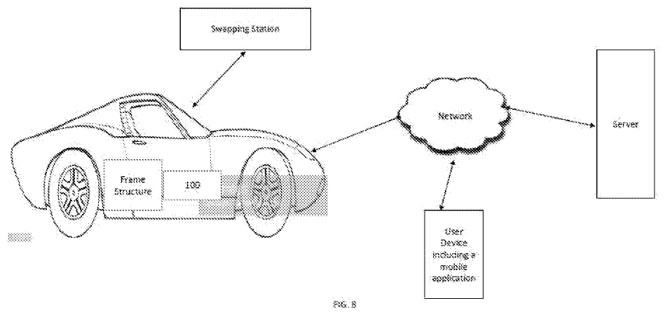

In the present embodiment, the casing 110 is adapted to be affixed to an entity. In the present embodiment, the casing 110 is affixed to a frame structure of an electric vehicle as shown and explained in FIG. 8 later using means such as, but not limited to, fasteners 128 as shown in FIG. 2. In an alternate embodiment, the casing 110 can be casted along with the frame structure to form one single piece or can be welded to the frame structure.

The casing 110 is affixed to the frame structure in a horizontal direction. More particularly, the first plane 112 and the third plane 116 are parallel to the frame structure. In an alternate embodiment, the casing 110 is affixed to the frame structure in a vertical direction. More particularly, the first plane 112 and the third plane 116 are perpendicular to the frame structure and the second 114 and the fourth plane 118 are parallel to the frame structure.

Further, while disposing the battery pack within the casing 110, it is required to ensure that the orientation of the battery pack should match with that of the casing 110. For example, if the casing 110 is affixed to the frame structure of the vehicle in a horizontal direction, then the battery pack 150 should also be disposed within the casing 110 in horizontal direction. Further, if the casing 110 is affixed to the frame structure of the vehicle in the vertical direction, then the battery pack 150 should also be disposed within the casing 110 in the vertical direction.

It is to be noted that the battery pack 150 has multiple applications such as, but not limited to, electric vehicles, telecom sector, home appliance industries, and back-up systems such as servers, databases, etc. By describing the battery pack for the electric vehicle application should nowhere be construed to be limiting the scope of the present disclosure to only electric vehicles.

With reference to FIG. 3, a first pair of rail elements 130 having a first length (L1) is defined on an inner surface 142 and parallel to a longitudinal axis X-X′ of each of the first side plane 112 and the third side plane 116.

Further, a first pair of guide elements 132 having a second length L2 is defined on the inner surface 142 and parallel to the longitudinal axis X-X′ of each of the first side plane 112 and the third side plane 116. In an alternate embodiment, the first pair of guide elements 132 can be defined on one of the first side plane 112 and the third side plane 116 respectively.

With reference to FIG. 3, the first length (L1) of the first pair of rail elements 130 is greater than the second length (L2) of the first pair of guide elements 132. In an alternate embodiment, the second length (L2) can be greater than the first length (L1).

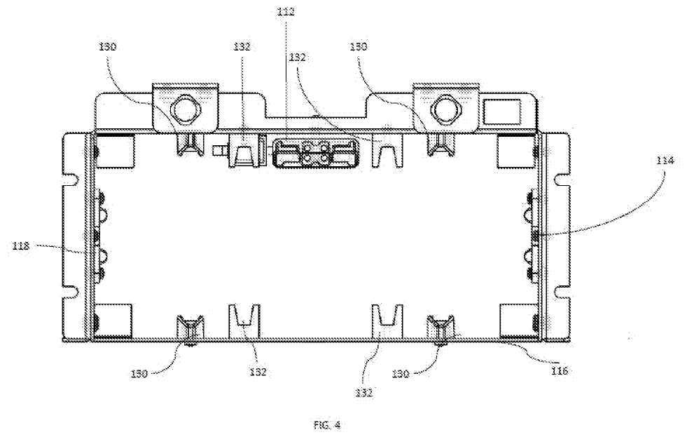

FIG. 4 illustrates a front view of the casing 110. As seen in the said figure, each of the first pair of rail elements 130 defined on the first side plane is in line with each of the first pair of rail elements 130 defined on the third side plane.

Further, with reference to FIG. 4, each of the first pair of guide elements 130 defined on the first side plane 112 is in line with each of the first pair of guide elements 130 defined on the third side plane 116.

In an embodiment, the first side plane 112 and the third side plane 116 of the casing 110 can include more than the first pair of rail elements and the first pair of guide elements. In yet another embodiment, the first side plane and the third side plane can include a plurality of rail elements and a plurality of guide elements, not limiting to configurations in pairs. In this regard, it is to be noted that disclosing only first pair of rail elements and only one pair of guide elements should nowhere be construed as limiting the scope of the present disclosure.

With reference to FIG. 3, the first pair of guide elements 132 is positioned in between the first pair of rail elements 130 on the inner surface 142 of each of the first side plane 112 and the third side plane 116. In an alternate embodiment, the first pair of guide elements 132 is positioned in between the first pair of rail elements 130 on the inner surface 142 of one of the first side plane 112 and the third side plane 116. Advantageously, by symmetrically defining the first pair of rail elements 130 and the first pair of guide elements 132 on the inner surface 142 of the first and the third side plane (112, 116) provides balance to the casing 110 affixed to the frame structure of the vehicle. Further, in the event of disposing the battery pack 150 within the casing 110, the casing 110 is adapted to withstand the heavy weight of the battery pack. Furthermore, the casing 110 ensures that the heavy weight of the battery pack 150 is not distributed to the other parts of the vehicles.

Each of the first pair of rail elements 130 is positioned at a first predetermined distance (d1) from each other and at a second predetermined distance (d2) from the longitudinal axis X-X′. In the present embodiment, the second predetermined distance (d2) is equivalent to one half of the first predetermined distance (d1).

Each of the first pair of guide elements 132 is positioned at a third predetermined distance (d3) from each other as shown in FIG. 3.

With reference to FIG. 1, a first connector 134 is coupled on the inner surface 142 and adjacent to a first end 136 of one of the first and the third side plane (112, 116) and positioned in between the first pair of guide elements 132 as also as shown in FIG. 3. In an embodiment, the first connector 134 is coupled to the inner surface 142 of the first and the third side plane (112, 116) by one of, but not limited to, fasteners 144. In an alternate embodiment, the first connector 134 can also be welded to the casing 110.

The first connector 134 of the casing 110 is interconnected to operational components of the electric vehicle. As shown in FIG. 1, one end 146 of the first connector 134 is interconnected to operational components of the electric vehicle.

As shown in FIG. 3 and also partially shown in FIG. 2, each of the second plane 114 and the fourth plane 118 of the casing 110 include a first pair of anti-friction members 138 and a second pair of anti-friction members 140 on their respective inner surfaces 142. Advantageously, the first and the second pair of anti-friction members (138, 140) defined on the second and the fourth plane (114, 118) respectively facilitate in preventing friction between the battery pack 150 and the casing 110 and enabling a smooth transition in the event of sliding the battery pack within the casing.

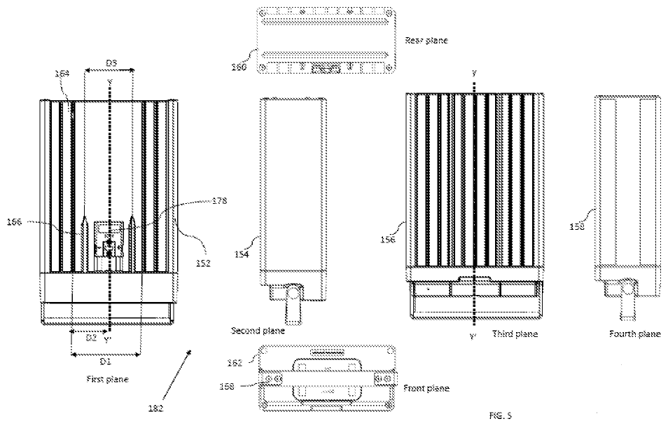

FIG. 5 illustrates an outer surface 182 of each plane of the battery pack 150 of FIG. 1. The battery pack 150 is adapted to be slidably disposed within the casing 110. In the present embodiment, the battery pack 150 includes six sides namely a first plane 152, a second plane 154, a third plane 156, a fourth plane 158, a rear plane 160 and a front plane 162. In this regard, it is to be noted that the battery pack 150 including six sides should nowhere be construed as limiting the scope of the present disclosure.

In the present embodiment as shown in FIG. 5, a second pair of guide elements 164 is defined on the outer surface 182 of the first plane 152 and the third plane 156, respectively. The second pair of guide elements 164 is positioned parallel to a longitudinal axis Y-Y′.

Further, a second pair of rail elements 166 is defined on the outer surface 182 of the first plane 152. The second pair of rail elements 166 is positioned parallel to the longitudinal axis Y-Y′.

In an alternate embodiment, the second pair of rail elements 166 is defined on the outer surface 182 of the first plane 152 and the third plane 156, respectively.

In the present embodiment, length of the second pair of guide elements 164 is greater than the length of the second pair of rail elements 166.

In an alternate embodiment, the length of the second pair of guide elements 164 is lesser than the length of the second pair of rail elements 166.

With reference to FIG. 5, the second pair of rail elements 166 is positioned in between the second pair of guide elements 164 on the outer surface of one of the first side plane 152 and the third side plane 156. In an alternate embodiment, the second pair of rail elements 166 is positioned in between the second pair of guide elements 164 on the outer surface 182 of each of the first side plane 152 and the third side plane 156, respectively.

In the present embodiment, each of the second pair of guide elements 164 is positioned at a first predetermined distance (D1) from each other and at a second predetermined distance (D2) from the longitudinal axis Y-Y′, the second predetermined distance (D2) is equivalent to one half of the first predetermined distance (D1).

Further each of the second pair of rail elements 166 is positioned at a third predetermined distance (D3) from each other as shown in FIG. 5.

In order to smoothly dispose the battery pack 150 within the casing 110 and to ensure that the battery pack 150 is aligned with the casing 110, the distance d1 is required to be equal to distance D1. Distance d2 is required to be equal to D2. Further, the distance d3 is required to be equal to D3. Further, it is required to ensure that the dimensions of the second pair of guide elements 164 and the second pair of rail elements 166 of the battery pack 150 should be such that they can slide through the first pair of rail elements 130 and the first pair of guide elements 132 of the casing 110 to form different connections. Once the above is taken care, the battery pack 150 can be disposed within the casing 110.

At the outset, the battery pack 150 is lifted using a handle bar 168 and the rear plane 160 as shown in FIG. 5 is slidably disposed within the casing 110 using the handle bar 168. A second connector 178 of the battery pack 150 is positioned opposite to the rear plane 160.

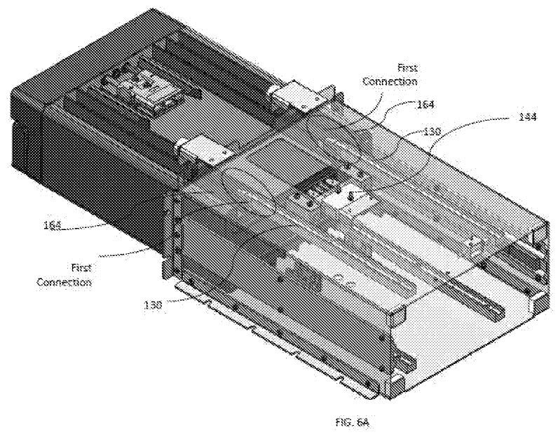

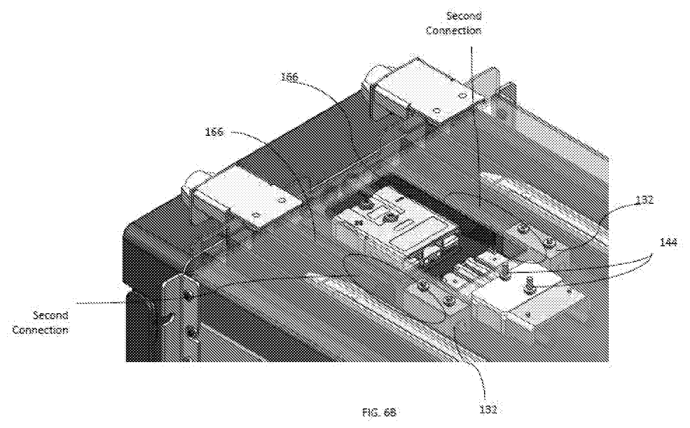

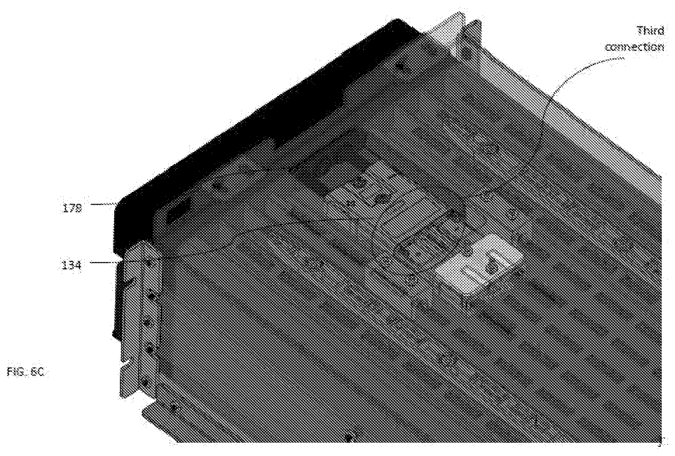

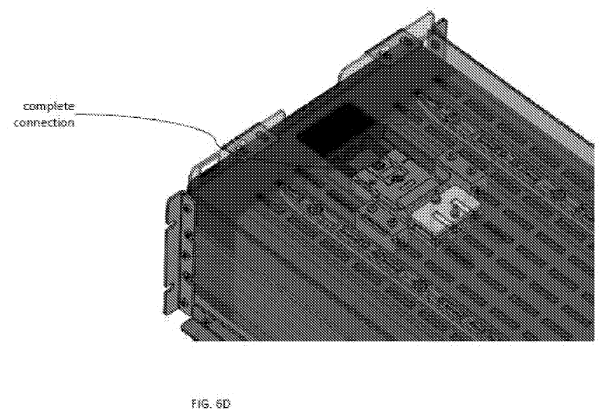

Once the rear plane 160 of the battery pack 150 is slid through the casing 110, the first pair of rail elements 130 of the battery pack 150 engage with the second pair of guide elements 164 of the battery pack 150 to form a first connection as shown in FIG. 6A.

Once the battery pack 150 is further slid through the casing 110 using the handle bar 168, the first pair of guide elements 132 of the casing 110 engage with the second pair of rail elements 166 of the battery pack 150 to form a second connection as shown in FIG. 6B. The second connection is formed only after the first connection is complete.

Once the battery pack 150 is further slid through the casing 110 using the handle bar 168, the first connector 134 of the casing 110 is received within the second connector 178 of the battery pack 150 to form a third connection as shown in FIG. 6C. The third connection is formed only after the second connection is complete.

FIG. 6D is a perspective view illustrating a complete connection formed in the event of disposing the battery pack 150 within the casing 110, subsequent to establishment of the first connection, second connection and the third connection, according to one or more embodiments of the present invention. When a stage of complete connection is formed between the battery pack 150 the casing 110, then battery pack 150 is configured to provide power to the electric vehicle.

In an alternate embodiment, the first pair of rail elements 130 of the casing 110 and the second pair of guide elements 164 of the battery pack 150 can also be a rack and a pinion arrangement. Similarly, the first pair of guide elements 132 of the casing 110 and the second pair of rail elements 166 of the battery pack can also be a rack and a pinion arrangement.

Immediately after the complete connection is formed between the casing 110 and the battery pack 150, a first interlocking element 170 of the outer surface 182 of the battery pack 150 engages with a second interlocking element 172 of the casing 110. In response to engagement of the first interlocking element 170 with the second inter locking element 172, the battery pack 150 is in a locked position with the casing 110. The locked position ensures that the battery pack 150 cannot be disengaged from the casing 110.

The second interlocking element 172 can include mechanisms such as one of, but not limited to, linear type actuators, plunger type actuators. In the present embodiment, a solenoid is used as the first interlocking element 172.

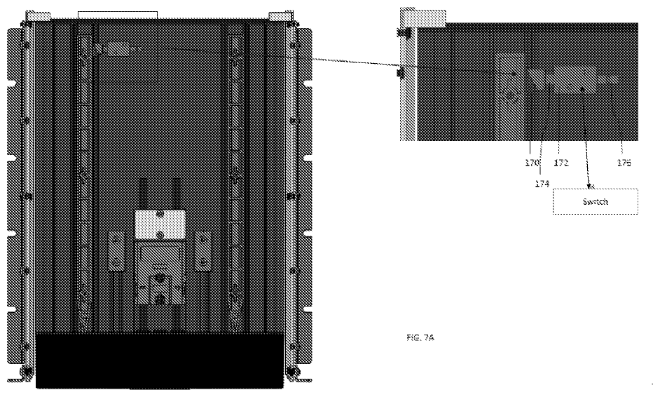

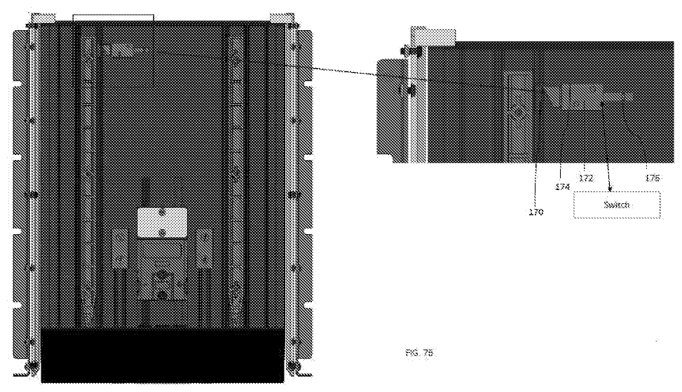

FIG. 7A, illustrates the first interlocking element 170 and the second interlocking element 172. The second interlocking element 172 herein the solenoid includes a spring 174 a plunger 176 and. The spring 174 is in a compressed state until the complete connection is formed between the casing 110 and the battery pack 150. Immediately after the complete connection is formed between the casing 110 and the battery pack 150, the first interlocking element 170 herein the cut out portion (also shown in FIG. 2) is exposed to the spring 174 of the second interlocking element 172. Due to the hollow nature of the cut out portion of the first interlocking element 170, the spring 174 expands and gets fitted within the cut out portion as shown in FIG. 7A, thereby locking the casing 110 with the battery pack 150 and thus forming a locked position.

The battery pack 150 can be detached from the casing 110 by using a switch operatively coupled to the second interlocking element 172. The switch can be manually or remotely controlled. FIG. 7B, shows the unlock position of the second interlocking element 172 with respect to the first interlocking element 170. With the help of the switch, the plunger 176 is pulled which results in compressing the spring 174, thereby pulling out the spring 174 from the cut out portion of the first interlocking element 170, thereby changing the closed position to the unlocked position.

In an embodiment of the invention, while disposing the battery pack 150 within the casing 110, the first pair of anti-friction member 138 and the second pair of anti-friction member 140 present on the inner surface 142 of the second and the fourth side planes (114, 118) respectively of the casing 110 facilitate in preventing friction between the battery pack 150 and the casing 110. Advantageously, enabling a smooth transition in the event of sliding the battery pack 150 within the casing 110.

The first connector 134 and the second connector 178 can be one of, but not limited to, Anderson connectors, blind mate connectors, hot swap connectors, IP 67 connectors, modular connectors and power connectors. In the present embodiment, the first and the second connectors 178 are Anderson connectors. Advantageously, the usage of the Anderson connectors is cost effective.

In an embodiment, the dimensions of the battery pack 150 should be designed in such a manner that when the battery pack 150 is slidably disposed within the casing 110, the battery pack 150 is completely disposed within the casing 110 as shown in FIG. 6D. If the dimensions of the battery pack 150 are such that even after the complete connection is formed pursuant to disposing the battery pack 150 within the casing 110, a part of the battery pack 150 is still lying outside the casing 110, then there is a problem of occupying a fair bit of space of the electric vehicle.

Further, the battery pack 110 should match the shape of the casing 110. For example, if the casing 110 is of the shape of a cuboid, then the battery pack 150 should also be designed to be cuboidal in shape.

In the present embodiment, the battery pack 150 and the casing 110 are not limited to a specific dimensions and capacities. The battery pack system 100 can be designed with different ranges of dimensions and capacities to be used for different applications. For example, the dimensions and capacity of the battery pack system 100 for an electric vehicle can vary depending on whether the vehicle is a two-wheeler, three-wheeler, four-wheeler, etc. Nowhere in the specification should it be construed that the battery pack system 100 is used for one specific application, and thereby limiting the scope of the present invention. Further, if the battery pack system 100 is used for a telecom tower, then perhaps the battery pack system 100 required may be bigger than for a home appliance.

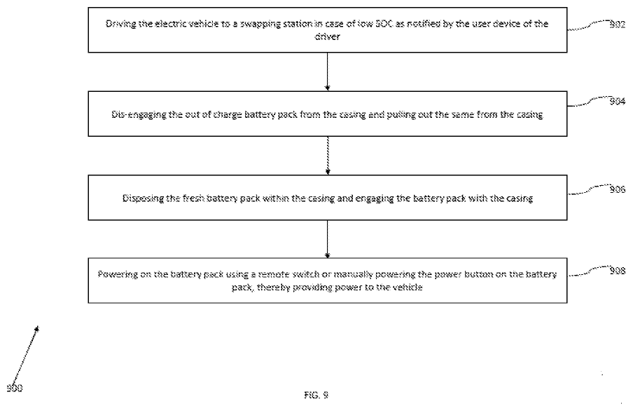

A working example of the swappable battery pack system 100 is explained hereunder with reference to FIG. 8 and FIG. 9.

Let us consider, the battery pack 150 is used to power the electrical vehicle. In the present example, let us assume the battery pack 150 is already disposed within the casing 110 of the swappable battery system 100 as shown in FIG. 8. The casing 110 is affixed to the frame structure of the vehicle. It is well known in the art that the state of charge (SOC) of a battery pack 150 is dependent on the distance covered by the vehicle. Hence, the state of charge of the battery pack 150 gradually decreases in response to the distance covered by the vehicle and eventually the battery pack 150 runs out of charge. Usually, in the electric vehicle, the driver is notified of the SOC of the battery pack 150 via an application on the user device such as, but not limited to, a mobile, a tablet, a desktop or a display unit present within the vehicle. The use device is notified of the SOC by a telematics unit embedded within the battery pack 150. As shown in FIG. 1, the battery pack 150 includes a telematics unit 180 which is configured to wirelessly communicate with the user device over the internet regarding SOC and various other parameters of the battery pack 150. When the driver is notified that the SOC parameter is critical, the vehicle has to be driven to a nearby swapping station to swap the out of charge/almost out of charge battery pack 150 with the fresh battery pack 150. Once the vehicle reaches the swapping station, the driver or any other person skilled in the art is required to pull out the battery pack 150 from the casing 110. Before pulling out the battery pack 150 from the casing 110, the switch is operated manually or remotely to ensure the locked position is changed to the unlocked position between the battery pack 150 and the casing 110. Once the unlocked position is reached, the battery pack 150 is pulled out of the casing 110 using the handle bar 168.

While pulling out the battery pack 150 from the casing 110, at the outset, the third connection formed between the first connector 134 of the casing 110 and the second connector 178 of the battery pack 150 is broken. Thereafter, the second connection formed between the first pair of guide elements 132 of the casing 110 and the second pair of rail elements 166 of the battery pack 150 is broken. Thereafter, the first connection formed between the first pair of rail elements 130 of the casing 110 and the second pair of guide elements 164 of the battery pack 150 is broken. Finally, the out of charge battery pack 150 can be completely removed from the casing 110.

Once the out of charge battery pack 150 is pulled out of the casing 110, the fresh battery pack 150 is disposed within the casing 110. As described earlier, in the event of disposing the battery pack 150 within the casing 110, the first pair of rail elements 130 of the casing 110 engage with the second pair of guide elements 164 of the battery pack 150 to form the first connection. Thereafter, the first pair of guide elements 132 of the casing 110 engage with the second pair of rail elements 166 of the battery pack 150 to form the second connection. Thereafter, the first connector 134 of the battery pack 150 is received within the second connector 178 to form the third connection. Thereafter, the first interlocking element 170 of the battery pack 150 engages with the second interlocking element 172 of the casing 110, thereby locking the battery pack 150 with the casing 110. Subsequent to this, the battery pack 150 is switched on to power the electric vehicle. The battery pack 150 can be switched on manually by powering on the power button located on the battery pack 150. Further, the battery pack 150 can be remotely switched on using the user device which is wired and/or wirelessly connected to the battery pack 150.

Further, a server as shown in FIG. 8 is in wireless communication with the user device. The server is configured to update the application running on the user device. Further, the server including a database is configured to maintain copy of the data. The server can also remotely monitor the swappable battery pack system 100 in cases of critical situations such as, but not limited to, low SOC. The server can also provide graphical representation of the SOC of the battery pack on the application running on the user device.

### INDUSTRIAL APPLICABILITY

The present invention provides a swappable battery pack system to be utilized in sectors such as transportation, telecom, computing systems, home appliances, etc. In an embodiment, the swappable battery pack system 100 can be utilized in electric vehicles. The swappable battery pack system 100 includes a casing 110 having a first, a second, a third and a fourth side plane coupled to each other to define a hollow space. A first pair of rail elements 130 having a first length (L1) is defined on an inner surface 142 and parallel to a longitudinal axis X-X′ of each of the first and the third side plane. A first pair of guide elements 132 having a second length (L2) is defined on the inner surface 142 of one of the first and the third side plane and parallel to the longitudinal axis (X-X′) of one of the first and the third side plane. A first connector 134 is coupled on the inner surface 142 and adjacent to a first end of one of the first and the third side plane and positioned in between the first pair of guide elements 132. A battery pack 150 is adapted to be slidably disposed within the casing 110. The battery pack 150 includes a second pair of guide elements 164 and a second pair of rail elements 166 defined on an outer surface of the battery pack 150 so as to abut against the first pair of rail elements 130 and the first pair of guide elements 132, and a second connector 178 coupled to one end of the outer surface of the battery pack 150. In the event of sliding the battery pack 150 within the casing 110, the first pair of rail elements 130 of the casing 110 engage with the second pair of guide elements 164 of the battery pack 150 to form a first connection. The first pair of guide elements 132 of the casing 110 engage with the second pair of rail elements 166 of the battery pack 150 to form a second connection subsequent to the first connection. The first connector 134 of the casing 110 is received within the second connector 178 of the battery pack 150 to form a third connection subsequent to the second connection, thereby providing electric power to an entity affixed to the casing 110. The first pair of anti-friction member 138 and the second pair of anti-friction member 140 of the casing 110 prevent any kind of friction and enable smooth transition, when disposing the battery pack 150 within the casing 110 or pulling out the battery pack 150 from the casing 110. Further, the first pair of rail elements 130 of the casing 110 and the second pair of second pair of guide elements 164 of the battery pack 150 in combination with the first pair of guide elements 132 of the casing 110 and the second pair of rail elements 166 of the battery pack 150 facilitate in disposing/pulling out the battery pack 150 within/from the casing 110 respectively. Advantageously, even though the battery pack 150 is heavy in nature, the battery pack can easily be disposed within the casing or pulled out from the casing 110 by the driver. In this regard, the first connector 134 of the casing 110 and the second connector 178 of the battery pack 150 are properly interconnected and the first connector 134 is not damaged by the battery pack 150.

Further, since the third connection is formed between the first connector and the second connector, only subsequent to formation of the first connection and the second connection in order, ensures that the third connection between the first connector and the second connector remains intact irrespective of any impacts caused by movement of the vehicle.

Further, the swappable battery pack system 100 as claimed in the present invention can be retrofitted to converted electric vehicles without having to change the internal structural configurations of the frame structure of the vehicle.

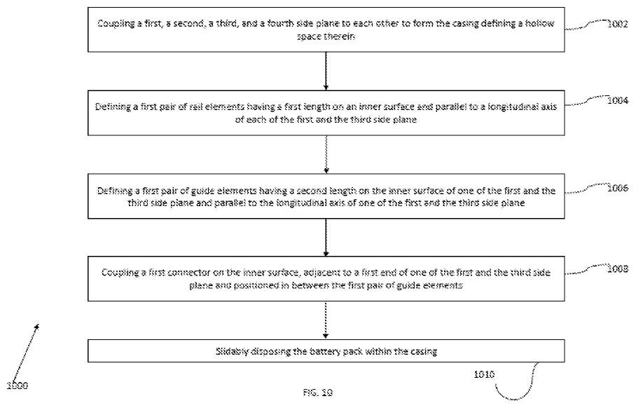

FIG. 10 is a flow chart of a method 1000 of providing a battery pack 150 within a casing 110. For the purpose of description, the method 1000 is to be read with description for the figures FIG. 1-FIG. 7 of the present invention as illustrated above.

At step 1002, the method 1000 includes coupling a first, a second, a third, and a fourth side plane (112, 114, 116, 118) to each other to form the casing 110 defining a hollow space therein. The four side planes can be coupled to each other by one of, but not limited to, fasteners, welding and molding. The four side planes are as shown in FIG. 3.

Further, the casing 110 includes two open ends as shown in FIG. 1. The front open end 120 is adapted to receive the battery pack 150. The rear open end 122 includes a plurality of blockers 124 to arrest the movement of the battery pack 150 beyond the rear open end 122, once it is disposed within the casing 110. In in the present embodiment, four blockers 124 are present on the periphery of the rear open end 122.

In an alternate embodiment, the casing 110 may have a rear plane coupled to the four side planes namely the first side plane 112, the second side plane 114, the third side plane 116 and the fourth side plane 118. The rear plane ensures that the movement of the battery pack 150 is arrested beyond the rear plane.

In an embodiment, the first side plane 112 is oppositely positioned to the third side plane 116 and the second side plane 114 is oppositely positioned to the fourth side plane 118 as shown in FIG. 2.

With reference to FIG. 2, the front open end 120 is adapted to receive the battery pack 150.

At step 1004, the method 1000 includes defining a first pair of rail elements 130 having a first length on an inner surface 142 and parallel to a longitudinal axis X-X′ of each of the first and the third side plane. The term “defining” the first pair of rail elements 130 on the first and the third side plane includes one of, but not limited to, carving, molding and coupling. The first pair of rail elements 130 can be coupled to the first and the third side plane (112, 116) by means such as fasteners and welding. With reference to FIG. 3, a first pair of rail elements 130 having a first length (L1) is defined on an inner surface 142 and parallel to a longitudinal axis X-X′ of each of the first side plane and the third side plane.

At step 1006, the method 1000 includes defining a first pair of guide elements 132 having a second length (L2) on the inner surface 142 of one of the first and the third side plane and parallel to the longitudinal axis X-X′ of one of the first and the third side plane. The term “defining” the first pair of guide elements 132 on the first and the third side plane includes one of, but not limited to, carving, molding and coupling. The first pair of guide elements 132 can be coupled to the first and the third side plane by means such as fasteners and welding. The first pair of guide elements 132 having a second length L2 is defined on the inner surface 142 and parallel to the longitudinal axis X-X′ of each of the first side plane and the third side plane as shown in FIG. 3. In an alternate embodiment, the first pair of guide elements 132 can be defined on one of the first side plane and the third side plane respectively.

With reference to FIG. 3, the first pair of guide elements 132 is positioned in between the first pair of rail elements 130 on the inner surface 142 of each of the first side plane and the third side plane. In an alternate embodiment, the first pair of guide elements 132 is positioned in between the first pair of rail elements 130 on the inner surface 142 of one of the first side plane and the third side plane.

At step 1008, the method 1000 includes coupling a first connector 134 on the inner surface 142, adjacent to a first end of one of the first and the third side plane and positioned in between the first pair of guide elements 132. In the present embodiment, the first connector 134 used is an Anderson connector. The first connector 134 is coupled to the inner surface 142 of the first and the third side plane by one of, but not limited to, mounting on a mounting area (not shown) by means such as, one of, but not limited to, fasteners and welding, etc.

In an embodiment, the first connector 134 is interconnected to operational components of the electric vehicle.

At step 1010, the method 1000 includes slidably disposing the battery pack 150 within the casing 110. The battery pack 150 is slidably disposed within the casing 110 by using the handle bar 168 located on the front plane of the batter pack.

In the event of disposing the battery pack 150 within the casing 110, the first pair of rail elements 130 of the casing 110 engage with the second pair of guide elements 164 of the battery pack 150 forming a first connection.

Thereafter, the first pair of guide elements 132 of the casing 110 engage with the second pair of rail elements 166 of the battery pack 150 forming a second connection subsequent to the first connection.

Thereafter, the first connector 134 of the casing 110 is received within the second connector 178 of the battery pack 150 forming a third connection subsequent to the second connection, thereby providing electric power to an entity affixed to the casing 110.

Detailed description with reference to working and operation of the swappable battery pack 150 system is illustrated with reference to embodiments as illustrated in figures FIG. 1. —FIG. 7. of the present invention. Hence for the sake of brevity, similar description for the method 800 has been omitted to avoid repetition. The limited description provided for the figure FIG. 10. should nowhere be construed as a limitation to the scope of the present embodiment, but should be read with the description as provided for FIG. 1. —FIG. 7. above.

While aspects of the present invention have been particularly shown and described with reference to the embodiments above, it will be understood by those skilled in the art that various additional embodiments may be contemplated by the modification of the disclosed machines, systems and methods without departing from the scope of what is disclosed. Such embodiments should be understood to fall within the scope of the present invention as determined based upon the claims and any equivalents thereof.

1. A swappable battery pack system, the system comprising:
a casing (110) having a first, a second, a third and a fourth side plane (112, 114, 116, 118) coupled to each other to define a hollow space;
a first pair of rail elements (130) having a first length (L1) defined on an inner surface (142) and parallel to a longitudinal axis (X-X′) of each of the first and the third side plane;
a first pair of guide elements (132) having a second length (L2) defined on the inner surface (142) of one of the first and the third side plane and parallel to the longitudinal axis (X-X′) of one of the first and the third side plane;
a first connector (134) coupled on the inner surface (142) and adjacent to a first end (136) of one of the first and the third side plane and positioned in between the first pair of guide elements (132); and
a battery pack (150) adapted to be slidably disposed within the casing 110, the battery pack (150) having a second pair of guide elements (164) and a second pair of rail elements (166) defined on an outer surface of the battery pack (150) so as to abut against the first pair of rail elements (130) and the first pair of guide elements (132), and a second connector (178) coupled to one end of the outer surface of the battery pack (150);
wherein, in the event of sliding the battery pack (150) within the casing (110):
the first pair of rail elements (130) of the casing (110) engage with the second pair of guide elements (164) of the battery pack (150) to form a first connection;
the first pair of guide elements (132) of the casing (110) engage with the second pair of rail elements (166) of the battery pack (150) to form a second connection subsequent to the first connection; and
the first connector (134) of the casing (110) is received within the second connector (178) of the battery pack (150) to form a third connection subsequent to the second connection, thereby providing electric power to an entity affixed to the casing (110).

2. The system as claimed in claim 1, wherein the first plane (112) is oppositely positioned to the third plane (116), the second plane (114) is oppositely positioned to the fourth plane (118).

3. The system as claimed in claim 1, wherein the first length (L1) of the first pair of guide elements (132) is greater than the second length (L2) of the first pair of guide elements (132).

4. The system as claimed in claim 1, wherein each of the first pair of rail elements (130) defined on the first side plane (112) is in line with each of the first pair of rail elements (130) defined on the third side plane (116).

5. The system as claimed in claim 1, wherein the first pair of guide elements (132) is defined in between the first pair of rail elements (130) on the inner surface (142) of one of the first and the third side plane.

6. The system as claimed in claim 1, wherein each of the first pair of rail elements (130) is positioned at a first predetermined distance (d1) from each other and at a second predetermined distance (d2) from the longitudinal axis, the second predetermined distance (d2) equivalent to one half of the first predetermined distance (d1).

7. The system as claimed in claim 1, wherein each of the first pair of guide elements (132) is positioned at a third predetermined distance (d3) from each other.

8. The system as claimed in claim 1, wherein each of the second plane and the fourth plane of the casing (110) include a first pair of anti-friction members (138) and a second pair of anti-friction members (140) respectively to facilitate in preventing friction between the battery pack 150 and the casing (110) and enabling a smooth transition in the event of sliding the battery pack (150) within the casing (110).

9. The system as claimed in claim 1, wherein an outer surface (182) of the battery pack (150) includes a first interlocking element (170) adapted to engage with a second interlocking element (172) positioned on the inner surface (142) of the casing (110) to lock the battery pack (150) within the casing (110), the battery pack 150 being locked within the casing (110) subsequent to establishment of the third connection.

10. The system as claimed in claim 9, wherein a switch is electrically coupled to the first and the second interlocking elements (172), the switch adapted to be one of manually or remotely operated to lock and release the first and the second interlocking elements (172).

11. The system as claimed in claim 1, wherein the casing (110) includes a plurality of air vents (126) located on at least one of the first, second, third and fourth plane (112, 114, 116, 118) to dissipate heat during operation of the battery pack (150) within the casing (110).

12. A casing (110) for a swappable battery pack (150), the casing 110 comprising:
a first, a second, a third and a fourth side plane coupled to each other to define a hollow space;
a first pair of rail elements (130) having a first length (L1) defined on an inner surface (142) and parallel to a longitudinal axis (X-X′) of each of the first and the third side plane (112, 116);
a first pair of guide elements (132) having a second length (L2) defined on the inner surface (142) of one of the first and the third side plane and parallel to a longitudinal axis (X-X′) of one of the first and the third side plane (112, 116); and
a first connector (134) coupled to a first end of the inner surface (142) of one of the first and the third side plane (112, 116) and positioned in between the first pair of guide elements (132);
wherein in the event of sliding a battery pack (150) within the casing (110):
the first pair of rail elements (130) of the casing (110) engage with a corresponding second pair of guide elements (164) of the battery pack (150) to form a first connection;
the first pair of guide elements (132) of the casing (110) engage with a corresponding second pair of rail elements (166) of the battery pack (150) to form a second connection subsequent to the first connection; and
the first connector (134) of the casing (110) is received within a corresponding second connector (178) of the battery pack (150) to form a third connection subsequent to the second connection, thereby providing electric power to an entity affixed to the casing (110).

13. (canceled)

14. (canceled)

15. (canceled)

16. A method for providing a swappable battery pack within a casing,
the method comprising the steps of:
coupling a first, a second, a third, and a fourth side plane to each other to form the casing defining a hollow space therein;
defining a first pair of rail elements having a first length on an inner surface and parallel to a longitudinal axis of each of the first and the third side plane;
defining a first pair of guide elements having a second length on the inner surface of one of the first and the third side plane and parallel to the longitudinal axis of one of the first and the third side plane;
coupling a first connector on the inner surface, adjacent to a first end of one of the first and the third side plane and positioned in between the first pair of guide elements; and
slidably disposing the battery pack within the casing, the battery pack having a second pair of guide elements and a second pair of rail elements defined parallel to a longitudinal axis on an outer surface of the battery pack so as to abut against the first pair of rail elements and a first pair of guide elements, and a second connector coupled to one end of the outer surface of the battery pack, wherein in the event of sliding the battery pack within the casing:
the first pair of rail elements of the casing engage with the second pair of guide elements of the battery pack forming a first connection;
the first pair of guide elements of the casing engage with the second pair of rail elements of the battery pack forming a second connection subsequent to the first connection; and
the first connector of the casing is received within the second connector of the battery pack forming a third connection subsequent to the second connection, thereby providing electric power to an entity affixed to the casing.
